(19) United States
(12) Patent Application Publication
(10) Pub. No.: US 2005/0064597 A1
(43) Pub. Date: Mar. 24, 2005

(54) Sampling device for automatic elemental analysers

(76) Inventors: Leonardo Sisti, Redavalle (IT); Stephano Boursier Niutta, Napoli (IT)

Correspondence Address: LEVINE & MANDELBAUM, 444 MADISON AVENUE, 35TH FLOOR, NEW YORK, NY, 10022, US

(21) Appl. No.: 10/489,936

(22) PCT Filed: Sep. 18, 2002
(86) PCT No.: PCT/IB02/03837

(30) Foreign Application Priority Data
Sep. 19, 2001 (IT) TO2001A000895

(51) Int. Cl. G01N 35/00

(52) U.S. Cl. 436/43; 422/63

(57) ABSTRACT

A sampler for automatic elemental analysers, has a loading device, a guide containing an admission piston, a first purge chamber for a sample to be analysed, an admission system for a purge gas into the first purge chamber, the first purge chamber having a passage for the admission piston, the admission piston being movable between a drop position and admission position for the sample to be analysed. A second inner chamber in the sampler is disposed near the distal end of the admission piston.

The present invention relates to a sampling device, in particular for automatic elemental analysers, comprising loading means, a guide containing an admission piston, a first purge chamber for a sample to be analysed, a purge gas admission system into said first purge chamber, said purge chamber consisting of a passage in said admission piston, said admission piston being movable between a drop position and an admission position for the sample to be analysed.

This device is applicable, in particular, to chemical analysing instruments, such as automatic elemental analysers. This instrumentation is suitable for measuring the contents of carbon, nitrogen, hydrogen, sulphur and oxygen in organic or inorganic solid or liquid samples; it is also suitable for providing, for instance, a spectrometric test based on IRMS technique, Isotopic Ratio Mass Spectrometry, i.e. a special technique for measuring the mass isotopic ratio of the above elements.

An automatic elemental analyser as mentioned above is described in the Italian Utility Model n. BS 16853 filed by the present Applicant. Operation of this analyser is based on the principle of dynamic combustion, called “flash combustion” of a sample to be analysed, with addition of Oxygen; other elemental analysers operating by combustion without adding any oxygen (Pyrolysis), are used for measuring the oxygen contained in the sample. After combustion, the gases produced by the combustion or pyrolysis are passed by a carrier gas over special oxidizing catalysers for reaction completion. The gas flows through a reducing catalytic bed to eliminate oxygen excess and reduce nitrogen oxides to elemental nitrogen.

With reference to the elements to be analysed, the gases consisting of N₂, CO₂, H₂O, SO₂ flow through irreversible selective absorption traps and are mutually separated in a chromatographic column. The separated gases are detected by means of TCD and/or IR detectors and/or sent to an IRMS detector, the latter being suitable for measuring the isotopic contents of the elements themselves.

In practice, a common analyser is an instrument for analysing the elemental composition of carbon, hydrogen, nitrogen, sulphur, in a wide variety of sample materials, either in a solid or liquid form.

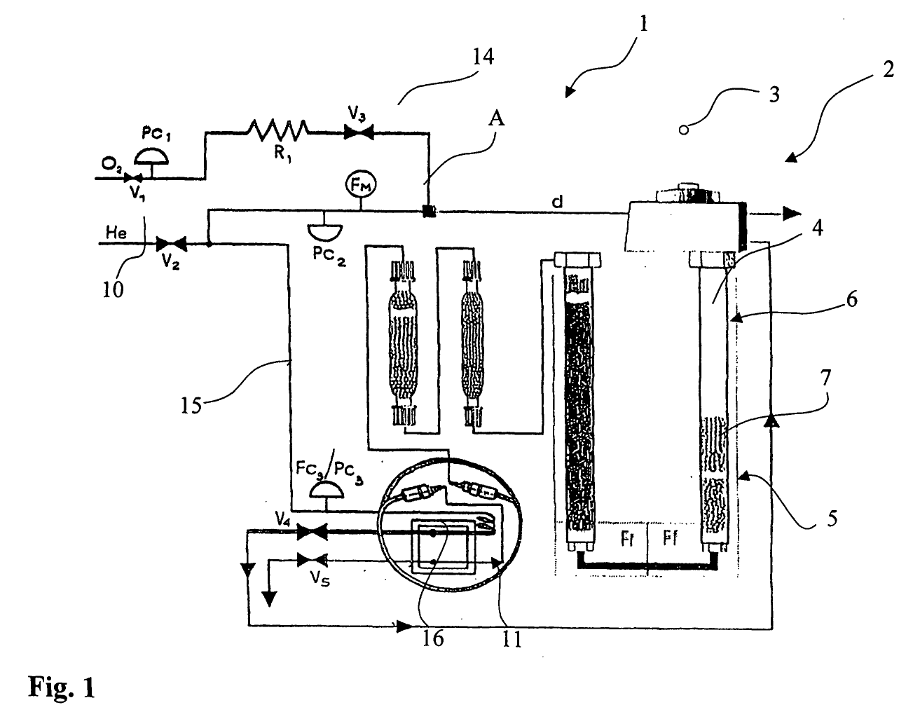

The annexed FIG. 1 illustrates a schematic representation of a known automatic elemental analyser, maintaining the technical symbols in use for the various operating devices of the analyser.

Both the type and operation of an automatic elemental analyser, as labelled in its whole with 1, may be schematised in the following operating units:
a sampler 2, being the object of the present invention, and being suitable for introducing a sample 3 to be analysed in a combustion reactor 4 with a continuous flow of carrying gas, also called carrier gas;
a combustion system comprising an oven 5, housing a reaction tube 6 appropriately manufactured for catalytic combustion of the sample 3 to be analysed, i.e. a combustion reactor 4 with a first catalytic bed 7 being suitable for favouring a combustion reaction of the sample 3, and a second catalytic bed 8 for reducing the oxygen excess introduced and nitrogen oxides produced;
traps 9 for irreversible elimination of the contents of CO₂ and H₂O, if required by the analytic configuration;
a gas chromatographic column 11 housed in an isothermal gas chromatographic chamber, not shown in the figure, for separating the gases obtained from the combustion;
a TCD detector 16 for detecting the individual gases after their separation;
a likely IR detector in series with the TCD detector 16, not represented in the figure for simplicity's sake;
a likely IRMS detector in series with the TCD 16 or IR detector, not represented in the figure for simplicity's sake;
a main pneumatic circuit 10 providing a constant carrier gas flow, usually helium or argon, through an electronic pressure regulator PC₂ and electronic flow meter F_{M}. Said carrier gas flows through the combustion reactors 4 and reduction reactors 8, traps 9 and chromatographic column 11, finally reaching the measuring cell of the TCD thermal conductivity detector 16;
a derived pneumatic circuit 15 for admitting first a reference gas in the TCD, which will subsequently act also as purge gas for a sample 3 to be analysed, said purge or reference gas being the same gas as the carrier gas mentioned above, i.e. helium or argon;
an automatic pneumatic oxygen measuring system 14, the pressure of which is programmed independently from the other circuits, which flows into the main pneumatic circuit 10 at a junction A;
an electronic system for controlling the operation of the various subsystems, not represented here for simplicity's sake. In particular, said electronic system comprises electronic pressure regulators, an electronic flow meter, the control circuits of the solenoid valves V₁, V₂, V₃ and temperature regulators of the oven 5 and of the GC chamber.

One gas line departs from one inert gas bottle not represented in the figure, usually delivering helium or argon, forming the main pneumatic circuit 10, from which the pneumatic circuit 15 previously described is derived for providing a constant flow of one gas called reference gas along a first path and purge gas along a subsequent path.

The automatic pneumatic oxygen measuring system 14 usually comprises an admission line for oxygen, a set of solenoid valves V₁ and V₃, an electronic pressure regulator PC₁, a calibrated restrictor R₁. This system can inject automatically predetermined amounts of oxygen, since it is able to control the oxygen admission pressure programmable independently from the gas amounts flowing into the main circuit 10.

As to operation and further specifications of the analyser, reference is made to the Italian Utility Model n. BS 16853 filed by the same Applicant.

In said automatic elemental analyser 1, said sampler 2 is used for introducing the sample 3 to be analysed into the combustion reactor 4, which is kept at a desired temperature by means of oven 5, the temperature of which, is electronically controlled by the above electronic system.

Said sampler 2 has to provide for admission of the sample 3 to be analysed without admission of ambient atmospheric gases, and likely polluting agents and fluids that may possibly be in contact with the above sampler 2. As better detailed in the following description, a purge step is performed for the sample 3 to be analysed. This purging step aims to completely wash a chamber, called hereafter purge chamber 34, from any atmospheric gases herein, said purging being executed by means of a constant purge gas flow through the purge chamber 34.

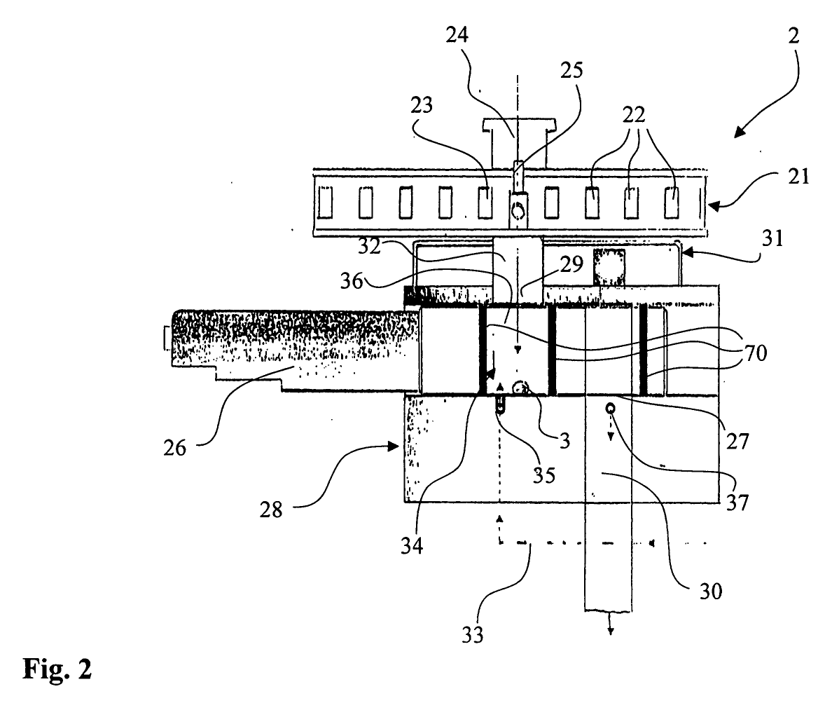

FIG. 2 is illustrating a schematic front view of a common art sampler, indicated in its whole as 2, a so-called “drawer” type, electrically or pneumatically actuated, which comprises:
a carousel device 21 housing the sample 3 to be analysed, consisting of a set of cavities 22 around its circumference; said carousel device 21 including usual technical elements, not represented here, that enable its rotation about a fulcrum point, for alignment of a cavity 23 with a drop position 24. Said carousel device 21 includes, in alignment with the drop position 24 and over, venting means 25 which includes a cover plate of light material, resting on carousel device 21; said venting means 25 allows the purge gas to flow out, said purge gas flowing over the carousel top face, upon which the cover rests, thus preventing ambient atmospheric gases to retro-diffusing into sampler 2;
an admission piston 26 for displacing the sample 3 to be analysed from said drop position 24 to a admission position 27 for its admission into reactor 4 of analyser 1. The movement of said admission piston is controlled by an appropriate electric or pneumatic actuation system not indicated in FIG. 1 for simplicity's sake;
a cylindrical guide 28, wherein the admission piston 26 comprising interlaying sealing rings 70 is moving longitudinally, has a first passage 29 on its upper side aligned with said drop position 24, and a second passage 30 on its lower side aligned with said admission position 27 for admitting sample 3 to be analysed into reactor 4 of analyser 1;
a joining block 31 between said carousel device 21 and said cylindrical guide 28, said joining block 31 having a passage 32 at drop position 24 for the sample 3 to be analysed;
a purge gas admission system 33 to a purge chamber 34, said purge chamber 34 being delimitated in said cylindrical guide 28 and in said joining block 31, where the admission piston 26 is in the drop position 24. Said position of the admission piston 26 may be defined as a “piston-out” position, i.e. a position corresponding to the configuration of sampler 2 illustrated in FIG. 2.

In particular, said purge gas admission system 33 allows said purge gas to flow into said purge chamber 34 for performing the purging step of sample 3 to be analysed. A purging step means the operation of removing the air molecules as well as other likely polluting substances in general, including gases absorbed by the surface of the capsule containing sample 3 to be analysed, through the action of a constant purge gas flow in the purge chamber 34 during the entire analysis cycle of a previous sample.

Said purge gas admission system 33 incorporates a diffuser 35 contained in a lower wall of said cylindrical guide 28; said diffuser 35 will then diffuse the purge gas from the bottom upwards. Said purge gas is conveyed there through an appropriate derivation of the purge gas admission system 33, not shown in FIG. 2.

From this short description, the purge chamber 34 consists of:
a passage 36 in the admission piston 26;
said passage 32 in the above joining block 31;
said first passage 29 in the upper wall of cylindrical guide 28;
a cavity 23 in the carousel device 21 aligned in the drop position 24 for the sample 3 to be analysed.

An inclined viewing mirror device 60, is positioned in the joining block 31, in the admission piston 26 and in the cylindrical guide 28. The admission piston 26 can slide in the cylindrical guide 28 by means of interposed sealing means 70. Through said “viewing mirror” device 60, sample 3 to be analysed can be viewed during the movement phases of the admission piston 26, and when said sample 3 drops into the reactor 4, and is also viewed to monitor combustion completion, called “flash” combustion, which is evidenced by a sudden bright flash due to a local temperature increase caused by the combustion itself.

Operation of a common sampler 2 is as follows:

The samples 3 to be analysed are previously introduced in appropriate capsules usually made from tin or silver. After having been weighed, they are individually placed in the set of cavities 22 of the carousel device 21, according to a predefined analytical sequence. After appropriate rotation of the carousel device 21 to the drop position 24, said sample 3 is displaced to passage 32 of said joining block 31, dropping into purge chamber 34 through the first passage 29 of the cylindrical guide 28, with admission piston 26 in its “piston-out” position.

Sample 3 to be analysed is flushed within purge chamber 34 by a continuous purge gas flowing from the purge gas admission system 33, where said diffuser 35 and the gas nature itself contribute to provide a fast diffusion into the purge chamber, with a flow of turbulent type, with consequent purging of said purge chamber 34.

After the completion of the analytical cycle for the previous sample in the analyser 1, the electric or pneumatic actuation system allows admission piston 26 to move longitudinally to a “piston-in” position.

The “piston-in” position is the specific piston position in which the inner passage 36 is positioned in the admission position 27. Thus sample 3 to be analysed is brought in line with the second passage 30 of the cylindrical guide 28 by the movement of the admission piston 26 and will drop into the reactor 4 of the analyser 1.

In order to complete the automatic sampling cycle, the admission piston 26 has to go back to its “piston-out” position, the carousel device 21 subsequently rotates to bring a second cavity 38 of the defined set of cavities 22 of the carousel device 21 to the drop position 24 for the next sample 3 (or element of the defined analytic sequence) to be analysed. Simultaneously the electric or pneumatic actuation system causes the admission piston 26 to shift longitudinally in a direction opposite to the previous movement, i.e. from its “piston-in” position to a “piston-out” position, for admission of the next sample 3 into the purge chamber 34.

It must be noted that the purge gas is the same as the gas used as carrier gas in the elemental analyser 1 and that the carrier gas starts its own path as from sampler 2. In particular, the carrier gas flows into the chamber at admission position 27 in the top part of the second passage 30 of the cylindrical guide through the carrier diffuser 37 in a downward direction.

Said common sampler 2 as previously described may not be able to prevent small amounts of ambient atmospheric gases from entering purge chamber 34 and the chamber at admission position 27.

Amounts of ambient atmospheric gases, even in minimum quantities, may compromise the analysis results; the extent of compromise becomes more significant when higher levels of precision are required. This represents a definite drawback of the common technique, in particular in the instance of analysis performed with ultra sensitive detectors, i.e. detectors able to detect infinitely small amounts of foreign elements in the sample to be analysed.

As it is well known in the prior art, analysis of the samples is performed according to a known procedure subtracting the values obtained by the so-called blank analysis from total value obtained for a particular sample analysis, blank being defined as the result of the analysis performed without introducing any sample material in the instrument. This procedure for specific applications cannot avoid isotopic fractionation or increase of background and related issues associated to those items.

Ambient atmospheric gases may enter into admission position 27 if sealing rings 70 show a non perfect gas tightness caused by its nature or caused by wear over a period of time due to admission piston movements from position piston-in to piston-out and vice versa. Those two movements taking place for a duration of time of less than one second may allow infiltration of ambient atmospheric gases from outside to the inside of the chamber at admission position 27.

The presence of ambient contaminant molecules in the chamber at admission position 27 can also be caused by a retro-diffusion phenomenon taking place in the purge chamber 34 of the ambient atmospheric gases during the purge phase of the sample 3 to be analysed: this retro-diffusion phenomenon is proportional to the difference in the concentration of gases present between the ambient atmospheric gases and the purge gas itself.

Elimination of the majority of undesired ambient atmospheric gases from purge chamber 34 takes place quickly at the beginning of the analytical cycle or analyser starting and becomes far more difficult when there is a need to eliminate the residual traces, due to the phenomenon of retro-diffusion of gases present in the ambient atmospheric gases. A competition or equilibrium takes place between said retro-diffusion of ambient atmospheric gases and said evacuation by the purge gas, both processes being related to gas concentration, pressure and speed.

The cylindrical shape of purge chamber 34, allows the purge gas, usually Helium or Argon, to diffuse with elimination of gas contaminants through the cover on the carousel device. Said cover, together with the passage from said purge chamber, are all parts of the venting means 25 for the purge gas. They present a considerable resistance to the retro-diffusion phenomenon previously described. They constitute an efficient filtration barrier against contaminant gases under the action of the continuous flow of purge gas.

The equilibrium that is achieved with all mentioned parameters is acceptable for the analysis of samples in some applications, while for other applications the level of equilibrium is unacceptable and constitute an insuperable limitation when trying to achieve the desired level of accuracy and also when combining with some other sophisticated analytical techniques like that of the use of mass detectors for the evaluation of isotopic ratio, leading to inaccuracies of the results.

In addition, increasing the purge gas flow does not allow, in the present reported conditions, a significant change in the quality of evacuation, a plateau being achieved that cannot be further improved.

It is the object of the present invention to eliminate the drawbacks described and to provide a sampling device in particular for automatic elemental analysers, which has improved features when compared with the known state of the art as previously described.

Accordingly, the main object of the present invention is to eliminate the presence of ambient atmospheric gases in the admission chamber of the sampler.

Another object of the present invention is to eliminate the retro-diffusion phenomenon in the purge chamber during the sampling phase of the sample to be analysed.

A further object of the present invention is to guide the drop of the sample within the purge chamber to facilitate and to rationalise the subsequent step of purging the sample itself.

In order to achieve these aims, it is the object of the present invention to provide a sampling device, in particular for elemental analysers, incorporating the features of the annexed claims and which forms an integral part of the description herein.

Further objects, features and advantages will become apparent from the following detailed description of a preferred embodiment of the present invention that is represented in the annexed drawings, which are supplied by way of a non-limiting example, wherein:

FIG. 1 is a schematic view of the whole elemental automatic analyser system according to the known art;

FIG. 2 is a schematic front view of a sampler according to the known art;

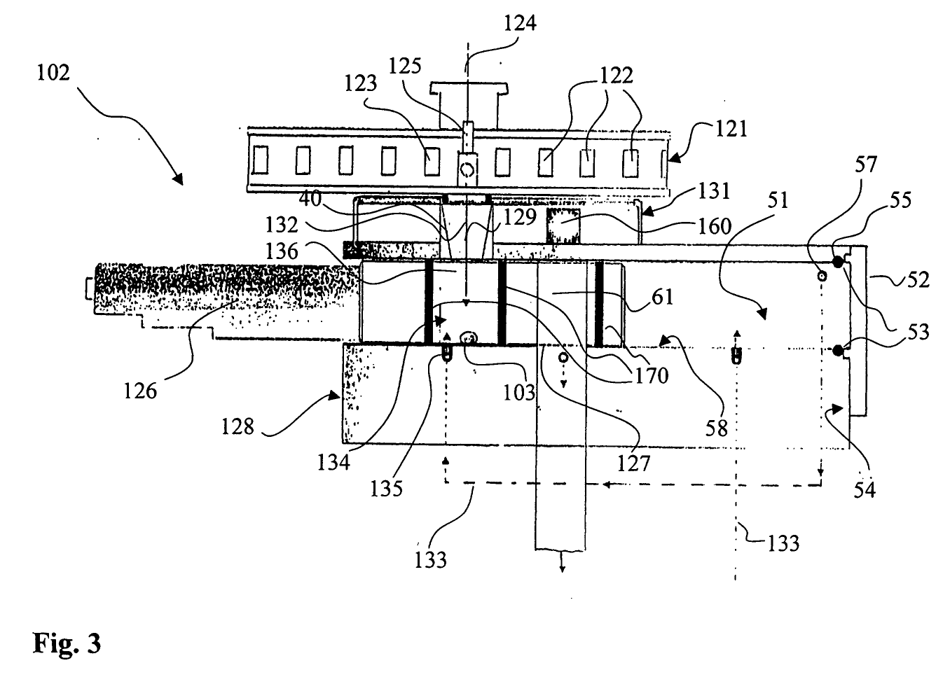

FIG. 3 is a schematic front view of a sampler according to the present invention;

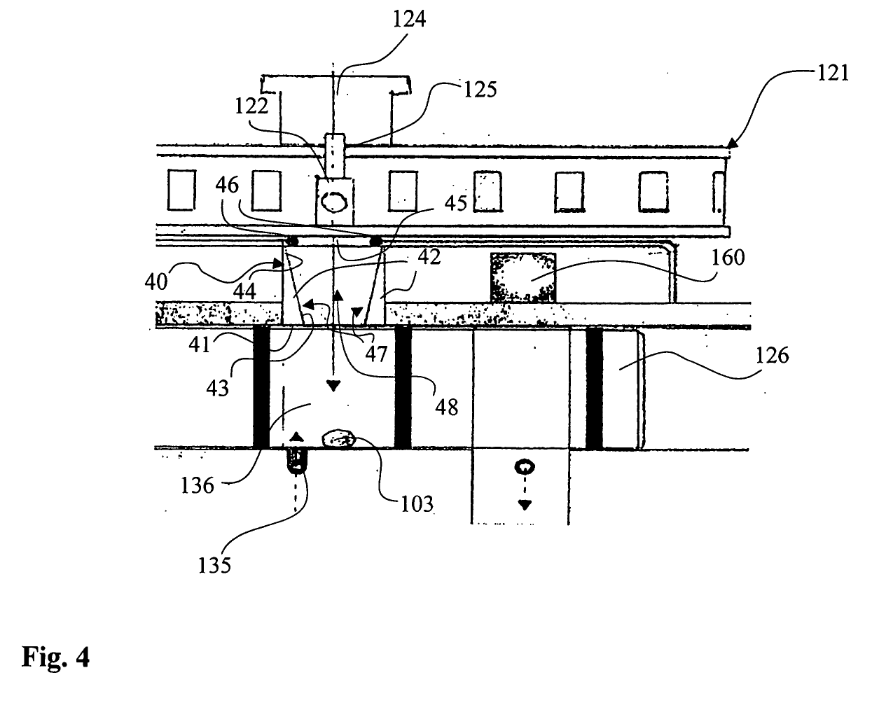

FIG. 4 is a more detailed schematic front view of the sampler in FIG. 3.

FIG. 3 is illustrating a sampler according to the invention, indicated in its whole as 102. Said sampler 102, in particular for automatic elemental analysers, is apt to avoid infiltration and retro-diffusion of ambient atmospheric gases into the sampler during the purge of a sample 103 to be analysed.

In FIGS. 3 and 4 the same references as those for the known sampler 2, are used but they are incremented 100.

The description of sampler 102 is completely similar to that of known sampler 2 to which detailed reference is made and with consideration of the differences and clarifications that are indicated subsequently.

In particular, purge chamber 134 that is an integral part of the sampler 102, in particular for automatic elemental analysers, is detailed in the annexed FIG. 4 and forms an integral part of sampler 102, according to the present invention. It comprises:
a passage 136 within an admission piston 126;
a passage 132 in the joining block 131;
   a cavity 123 of the carousel device 121 aligned at the drop position 124 for sample 103 to be analysed;
   means to direct the flow indicated as a whole as 40, apt to engage inside said purge chamber 134 in the space delimitated by passage 132 of said joining block 131 and a first passage 129 of the cylindrical guide 128, said means 40 extending through to and in contact with the lower face 41 of the upper wall of cylindrical guide 128.

In particular, said means to direct the flow 40 comprises a main element 42, which has a truncated cone shape and is arranged lengthwise inside the purge chamber 134; said main element 42 having a smaller section 43 located below and in communication with the upper section of the inner passage 136 within the admission piston 126.

At the other end, the portion with a larger section 44 of the main element 42 with a truncated conical shape is in communication with a drop passage 45 of the carousel device 121; the larger portion 44 being in contact with the drop passage 45 through the interposition of a sealing ring 46. The portion with the larger section 44 and the sealing ring 46 belongs to sealing means to provide gas tightness for said means to direct the flow 40.

The main element 42 of said means to direct the flow 40 comprises a sliding surface 47 with a truncated cone shape, delimitating said part of the larger section 44 and the smaller section 43, an internal duct 48 to the purge chamber 134, which is arranged lengthwise and diverging from the bottom upwards. It should be noted that a truncated conical surface is a surface of regular shape with its curved part at a very small angle, or zero. Said truncated conical shape of the sliding surface 47, allows to the fluid line of the purge gas adhere on said sliding surface 47 in order to substantially realise an unidirectional and non turbulent flow from the bottom upwards.

FIG. 3 shows a second chamber 51 internal to the sampler 102 itself, located over the head of said admission piston 126. The second chamber 51 is shaped internally to the cylindrical guide 128 in the space delimitated by the head of the admission piston 126 comprising its top sealing means 170, by the inner surface 58 of the cylindrical guide 128 being apt to guide admission piston 126 in its translational movement and by an end cap 52. Said end cap 52 closes said second chamber 51 in line with a wall 54 of the cylindrical guide 128, said wall 54 being located on the opposite side with respect to the head of admission piston 126. A First sealing means 53 is positioned between said end cap 52 and the wall of cylindrical guide 128 for hermetic gas tightness of the second chamber 51. In particular said first sealing means 53 includes sealing rings 53 located in appropriately shaped grooves 55.

Diffusing means for the purge gas, not represented in figure, are provided inside the lower part of said second chamber 51. Also in said second chamber 51 but in its upper section, at least one outlet 57 for the purge gas is available; said diffusing means and at least one outlet 57 are integral parts of the purge gas admission system 133. Thus the second chamber 51 allows a purge gas to flow through continuously and is exclusively filled with the purge gas.

Internally to the admission piston 126 and in distal proximity, next to purge chamber 134, a third chamber 61 is delimitated by an inner cylindrical passage, being an integral part of the viewing mirror device 160, and by two consecutive sealing means 170 of said admission piston 126. Said third chamber 61 is lying between the previous two chambers 134 and 51 to separate them.

It must be noted that admission system 133 is structured in such a way that one same gas, normally helium or argon, flowing out of a gas tank, not shown, and pertaining to the said admission system 133 divides into two directions to form the carrier gas and the purge gas. As schematically represented in FIGS. 1 and 3 and in common way, said admission system 133 is commonly structured with appropriate means for the purge gas to flow first into said second chamber 51 and then into the purge chamber 134 to vent out through venting system 125.

Operation of the sampler 102, in particular for automatic elemental analysers and according to the present invention is now described.

As far as the overall operation i.e. the sampling procedure of the samples 103 to be analysed, is completely similar to the operation of the known sampler 2 previously described. Hence reference is made to said operation as already described, where the numerical references in the relevant sections follow the numerical references of FIG. 1 incremented by 100. The operational features of the present invention as well as the specific operational differences of the present invention when compared to the prior art, are described below.

During the critical phase related to the risk of the unwanted phenomena of infiltration of atmospheric gases into the chamber at the admission position 127 and of retro-diffusion of ambient atmospheric gases into purge chamber 134 i.e. during the motion of the admission piston 126 from its “piston-in” position to the “piston-out” position, it can happen that:
A. the fast motion of admission piston 126, lasting about one second, using electric or pneumatic actuators not represented on the annexed figures, creates a slight depression within the inner passage 136 of the admission piston 126, causing an entrainment of external ambient atmospheric gases to the admission piston 126. Due to non-perfect sealing of sealing means 170, as already mentioned for sampler 2, the infiltration of gases can occur, but in this case from the second chamber 51 to the third chamber 61 i.e. differently from known samplers. In the case of the sampler 102 according to the present invention, said purge gas itself flows continuously through said second chamber 51, entering via diffusion means 56 and leaving via said outlet 57, thus avoiding infiltration of ambient atmospheric gases into the chamber at the admission position 127, and allowing the harmless infiltration of purge gas;
B. Diffuser 135 having its own outlet previously closed by said admission piston 126, is now free from hindrances and can start to admit purge gas into purge chamber 134. Motion of the purge gas, consisting of helium or argon, is directed by said diffuser 135 from the bottom upwards and diffuses naturally and in a swirling way inside the purge chamber 134. Said means to direct the flow 40 determines a dynamic pressure recovery and contributes to make the flow unidirectional eliminating the retro-diffusion phenomenon. The swirling characteristics of the purge gas flow at the inlet of the portion with a smaller section 43 of said main element 42, decrease as the purge gas flows through said main element 42, adhering according to the Coanda effect, to the regular diverging sliding surface 47. The regular and diverging shape of said sliding surface 47, diverging in the direction of purge gas flow facilitates gradual recovery of the gas pressure. The above pressure recovery makes the purge gas flow more evenly and unidirectionally, facilitating the evacuation of possible residues of ambient atmospheric gases by preventing retro-diffusion phenomena of ambient atmospheric gases from the cavity 122 of the carousel device 121;
C. At this stage, carousel device 121 brings the cavity 123 containing the sample 103 (or a sample according to the defined analytic sequence) to be analysed, in communication to the drop position 124 and with the diffuser 135 for purging sample 103 to be analysed.

In addition, during the drop stage of sample 103 to be analysed, from the cavity 123 of the carousel device 121, the sliding surface 47 of said means to direct the flow 40, being of truncated conical shape, directs the sample 103 to be analysed to a well identified position of said purge chamber 134.

It will be noted that the overall operation of the sampler is very similar to that described by the prior art; so for parts not mentioned, reference is made to the operation of the known sampler 2 as previously described, remembering that the numerical references are incremented by 100.

From the previous description, the features of the present invention and its advantages are clear.

The sampling device according to the present invention, using a second chamber in which purge gas is flowing, provides the advantage of eliminating the phenomenon of infiltration of ambient atmospheric gases into the chamber located internally to the admission piston at the admission position, due to an additional sealed chamber filled with purge gas in distal proximity of the said admission piston.

A further advantage of the sampling device according to the present invention is the use of specific means to direct the flow, which allow the complete elimination of retro-diffusion phenomena of ambient atmospheric gases into the purge chamber.

A further advantage of the sampling device according to the present invention is the ability to direct the sample to be analysed to drop at a precise position inside the purge chamber, thus facilitating and rationalising the subsequent operation of purging the sample itself.

The improvement obtained by the present invention is evidenced not only through standard procedures, but also by using ambient atmospheric gases contamination techniques i.e. by the artificial introduction of molecules not normally found in the ambient atmospheric gases. These techniques often rely on absolute methods of detection such as mass spectrometry.

1. A sampler for chemical analysing instruments comprising
loading means for one or more samples to be analysed,
a guide containing an admission piston for displacing the sample to be analysed from a drop position to an admission position for its admission into a reactor of an analyser, said piston having a head at one of its ends,
a first purge chamber for a sample to be analysed,
an admission system for a purge gas to said first purge chamber,
venting means for said purge gas associated at least to said purge chamber in such a way as to flow out from said sampler after having purged at least said purge chamber,
sealing means for said purge chamber, interposed between said guide and said admission piston,
said first purge chamber comprising a passage within said admission piston, said guide comprising a first passage substantially facing said loading means and aligned with said drop position for admitting the sample to be analysed into said first purge chamber and a second passage substantially aligned with said admission position for admitting the sample to be analysed into said reactor of the analyser,
further comprising a second chamber inside said sampler and closed to atmospheric gases, locatcd near the distal end of said admission piston part of said sealing means delimiting said second chamber.

2. A sampling device according to claim 1, wherein said second chamber is substantially disposed in said guide over the head of said admission piston.

3. A sampling device according to claims 1, wherein said second chamber comprises said head of said admission piston as one of its walls.

4. A sampling device according to the claim 1, wherein said second chamber comprises an inner surface of said guide as a further wall.

5. A sampling device according to claim 1, wherein said second chamber comprises an end cap in line with a wall of said guide as a its further wall.

6. A sampling device according to claim 1, wherein said second chamber has second sealing means between said end cap and said wall of said guide for hermetic closure of said second chamber.

7. A sampling device according to claim 6, wherein said first sealing means of said chamber comprise sealing rings housed in shaped grooves.

8. A sampling device according to claim 1, wherein said guide housing the admission piston has a substantially cylindrical shape.

9. A sampling device according to claim 1, wherein said second chamber comprises diffusion means for said purge gas inside the same chamber, said diffusion means pertaining to said admission system of said purge gas.

10. A sampling device according to claim 9, wherein said second chamber comprises at least an outlet for said purge gas, said outlet pertaining to said purge gas admission system and allowing the purge gas constant flow inside said second chamber.

11. A sampling device according to claim 9, wherein said diffusion means for said purge gas admission system are housed in a wall of said second chamber for a flow of said purge gas to be substantially directed from the bottom upwards.

12. A sampling device according to claim 1, wherein said loading means comprises a carousel device.

13. A sampling device according to claim 1, wherein said first purge chamber further comprises:
a passage of a joining block of the sampler, said joining block being disposed between said loading means and said guide;
a cavity of said loading means in line with the above drop position for the sample to be analysed.

14. A sampling device according to claim 1, further comprising means to direct the flow of said purge gas outward said first purge chamber, said means to direct the flow being suitable for engaging inside said first purge chamber.

15. A sampling device according to claim 1, wherein said means to direct the flow comprises a main element, being suitable for engaging inside said first purge chamber in the space delimited by said passage of said block and said first passage of said guide.

16. A sampling device according to claim 15, wherein said main element of said means to direct the flow comprises:
portion with a smaller section located below and in communication in its assembled state with an upper portion of passage of said admission piston,
a portion with a larger section communicating in its assembled state with a drop section of said loading means,
a sliding surface for the purge gas delimited inside said main element between said portion with a smaller section and said section with a larger section.

17. A sampling device according to claim 16, wherein the sliding surface of said main element is regularly diverging.

18. A sampling device according to claim 16, wherein said sliding surface of said main element comprises a curved surface at zero angle.

19. A sampling device according to claim 16, wherein said sliding surface of said main element is a surface having a substantially truncated cone shape.

20. A sampling device according to claim 14, wherein said flow conveying means in line with said drop section, comprise sealing means.

21. A sampling device according to the claim 20, wherein said sealing means comprise said portion with a larger section in contact with said drop section of said loading means, interlaying sealing ring.

22. A sampling device according to claim 1, wherein said admission system comprises means for conveying said purge gas through appropriate derivations of the admission system, first in said second chamber and then in said first purge chamber.

23. An automatic elemental analyser comprising said sampling device according to claim 1.

24. A sampling method for chemical analysing instruments, comprising the steps of:
placing one or more samples to be analysed into loading means disposed in a sampler according to a predefined analytical sequence;
positioning said loading means such in a way as to allow said sample to be admitted in a purge chamber for said sampler;
purging said sample to be analysed by a continues purge gas flowing from a purge gas admission system into said purge chamber;
introducing said sample to be analysed into a reactor of an analyser, by the means of an admission piston movement from a drop position, where the sample is able to be admitted into said purge chamber substantially comprised within said admission piston, to an admission position for its final introduction into said instrument;
said purge chamber being delimited by sealing means to avoid the atmospheric gases to enter said purge chamber during the operation of said admission pistons,
further comprising purging step for a second chamber, said second chamber being delimited by a part of said sealing means.

25. A sampling method, according to the claim 24, wherein said purging steps are operated with the same purge gas.

26. A sampling method, according to claim 24, wherein said purging steps are operated with the same purge gas flowing into said chemical analysing instrument, in particular an automatic elemental analyser.
